(19) United States
(12) Patent Application Publication
(10) Pub. No.: US 2005/0007760 A1
(43) Pub. Date: Jan. 13, 2005

(54) Multi-color chemiluminescent light device

(76) Inventor: Li-Fu Wu, Chu-Pei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/616,929

(22) Filed: Jul. 11, 2003

(51) Int. Cl. F21K 2/00

(52) U.S. Cl. 362/34

(57) ABSTRACT

A multi-color chemiluminescent light device is disclosed. The device emits different colors from different construction parts of the flexible outer container through varying the fluorescer types or incorporation ratios in different construction parts. Firstly, the fluorescer is incorporated into the material for forming the outer container so that the outer container will include the fluorescer after being injection molded. If there are two fluorecers respectively incorporated into the outer container and the hollow plug, the whole chemiluminescent light device will emit two lights. Consequently, the outer container can determine the color of light emitted by the chemiluminescent light device to have one single color or multiple colors.

### BACKGROUND OF THE INVENTION

1. Field of the Invention

This invention relates to a self-contained chemiluminescent light device, and more particularly to a self-contained multi-color chemiluminescent light device.

2. Description of the Prior Art

The art of generating light from chemical energy has been practiced for many years. Typically, a chemiluminescent light is generated by reacting a chemiluminescent oxalate component with a catalyzed hydrogen peroxide component (activator), wherein the most typical oxalate compound is Bis(6-carbopentoxy-2,4,5-trichlorophenyl)oxalate (so called “CPPO”), and the chemiluminescent oxalate component contains a fluorescer or fluorescers therein which are activated by the chemical energy generated by the oxalate-peroxide reaction so as to emit a light having a particular color. U.S. Pat. No. 3,749,679, U.S. Pat. No. 4,751,616, U.S. Pat. No. 3,888,786, U.S. Pat. No. 3,816,326 and U.S. Pat. No. 6,126,871 are fairly descriptive of such chemiluminescent systems.

Many of these fluorescer compounds are described in “Fluorescence and Phosphorescence” by Peter Pringsheim, Interscience Publishers, Inc., New York, N.Y., (1949), “The Colour Index”, Third Edition, Volume 4, The Society of Dyers and Colourists, and The American Association of Textile Chemists and Colorists(1971). Others are described in “Dye Lasers” by F. P. Scharfer, Editor, Springer Publishers, Berlin (1973) and also in “Eastman Laser Products”, Publication JJ-169, Eastman Kodak Company, Rochester, N.Y. (1977). The emission colors of some common fluorescers are shown in the following table:

| Fluorescer | Emission Color |
|---|---|
| 9,10-diphenylanthracene | blue |
| 9,10-bis(4-ethoxyphenyl)-2-chloroanthracene | blue |
| 9,10-bis(4-methoxyphenyl)-2-chloroanthracene | blue |
| 9,10-bis(phenylethynyl)anthracene | green |
| 1-chloro-9,10-bis(phenylethynyl)anthracene | yellow-green |
| 1,5-dichloro-9,10-bis(phenylethynyl)anthracene | yellow |
| 1,8-dichloro-9,10-bis(phenylethynyl)anthracene | yellow |
| Rubrene | orange |
| Rhodamine B | red |

Generally, a chemiluminescent light device includes a flexible and light-transmitting outer container and a rigid inner tube, see U.S. Pat. 4,508,642, for example. The chemiluminescent oxalate component can be placed in the space between the outer container and the rigid inner tube while the peroxide component is sealed into the rigid inner tube. Thus, when the outer container is bent and the rigid inner tube is broken, the two components are mixed and will react with each other to produce light.

In most of the prior arts, the chemiluminescent light device can only produce light in a spectral range, that is, only one specific color. If multi-color is desired at the same time by the same device, it is necessary to connect separate devices having different specific colors. This way increases the cost and labor. U.S. Pat. No. 5,158,349 provided a self-contained simultaneous multi-color chemiluminescent light device. The invention disclosed a device which includes concentric inner and outer tubes, wherein the inner tube contains multiple, segregated oxalate components having flurorescers of different colors. Upon activation, the device generates a distinct multi-color linear array of light. However, in order to prevent mixing between adjacent colors, the outer and the inner tube must be long and narrow, so that the tube wall can provide sufficient flowing resistance to preclude the mixing of adjacent chemiluminescent solutions of different colors. This characteristic is a serious disadvantage, severely limits the possible device shape it can present and decreases the versatility of employing chemical lighting devices.

### SUMMARY OF THE INVENTION

It is an object of the present invention to provide a simultaneous multi-color chemiluminescent light device.

It is another object of the present invention to provide a cost effective and easy to use multi-color chemiluminescent light device that does not require an impervious barrier or barriers separating two or more chambers that contain different oxalate-fluorescer mixtures.

It is a further object of the present invention to provide a multi-color chemiluminescent light device that does not require to contain more than one oxalate-fluorescer mixture within the device and also does not require a long and narrow shape to prevent the mixing between different oxalate-fluorescer mixtures as described in prior arts. Therefore, this invention can have versatile possibilities in the designs of their shapes.

This present invention provides a multi-color chemiluminescent light device which includes:
a. chemiluminescent oxalate component with fluorescer;
b. peroxide component;
c. a rigid inner tube defining an inner chamber; and
d. a flexible, transparent or translucent outer container with two or more construction parts.

One of the construction parts of the outer container incorporates no fluorescer and at least one of the construction parts of the outer container incorporates the flurorescer which has an emission maximum at a longer wavelength than that of the fluorescer in the chemiluminescent oxalate component and has an absorption spectrum overlapping a substantial portion of the emission spectrum of the fluorescer in the chemiluminescent oxalate component.

The flexible, transparent or translucent outer container and the rigid inner tube define an outer chamber therebetween. The chemiluminescent oxalate component can be placed in the outer chamber while the peroxide component is sealed into the inner chamber. Or, in a reverse order, the peroxide component can be placed in the outer chamber while the chemiluminescent oxalate component is sealed into the inner chamber.

Generally, the emission maximum of the fluorescer in the chemiluminescent oxalate component will be in the range between 280 and 900 nanometers, and its properties must be at least partially in compatible with the other compounds of the chemiluminescent oxalate component. The absorption maximum of the fluorescer incorporated in the construction parts of the outer container will be in the range between 320 and 950 nanometers. And a substantial portion of the absorption band of the fluorescer incorporated in the construction parts of the outer container must overlap with the emission band of the fluorescer in the chemiluminescent oxalate component, so that most of the light energy emitted by the fluorescer in the chemiluminescent oxalate component can be used to activate the fluorescer incorporated in the construction parts of the outer container and then transformed into a light at a longer wavelength.

Therefore, the light emitted by the fluorescer in the chemiluminescent oxalate component will not change color thereof when it transmits through the construction parts incorporating no fluorescer, and, at the same time, the light transmitting through the construction parts incorporating fluorescer will be transformed into a color having longer wavelength. Thus, the device emits lights of different colors from different construction parts of the flexible, transparent or translucent outer container. Therefore, this embodiment gives one self-contained simultaneous multi-color chemilumincescent light device.

Yet, another embodiment of this invention is to provide a device whose outer container has two or more construction parts, and all of the parts incorporate fluorescers having emission maximum at longer wavelengths than that of the fluorescer in the chemiluminescent oxalate component and having absorption spectra overlapping a substantial portion of the emission spectra of fluorescer in the chemiluminescent oxalate component. But, the fluorescer type or incorporation ratio of at least one of construction parts of the outer container is different from those of the other construction parts of the outer container. This condition ensures that the construction parts with the unique fluorescer type or incorporation ratio will emit different color from those of the other construction parts. Therefore, this embodiment gives another self-contained simultaneous multi-color chemilumincescent light device.

### BRIEF DESCRIPTION OF THE DRAWINGS

The drawings disclose an illustrative embodiment of the present invention, which serves to exemplify the various advantages and objects hereof, and are as follows:

FIG. 1 is a schematic view showing a glass ampule according to the present invention;

FIG. 2 is exemplarily showing a flexible, transparent or translucent outer container which includes two construction parts according to the present invention;

FIG. 2A is a front view showing a hollow plug of a multi-color chemiluminescent light device according to the present invention;

FIG. 3 is a vertical-sectional view showing a hollow plug and a cylindrical tube according to the present invention;

FIG. 4 is an elevational view showing an assembled multi-color chemiluminescent light device according to the present invention; and

FIG. 5 is a perspective drawing showing an assembled multi-color chemiluminescent light device according to the present invention.

### DETAILED DESCRIPTION OF PREFERRED EMBODIMENT

One preferred embodiment according to present invention is manufactured by the following procedures.

A. Preparation of Chemiluminescent Oxalate Component

Dissolve 67.5 grams of bis(6-carbopentoxy-2,4,5-tri-chlorophenyl)oxalate in one liter high quality dibutyl phthalate and heat the solution at 150° C. under nirtogen for one hour. Then, cool under nitrogen to 100° C. and add 1.90 grams of a fluorescer compound 9,10-bis(phenylethynyl)anthracene. Finally, cool to room temperature.

B. Preparation of Peroxide Component

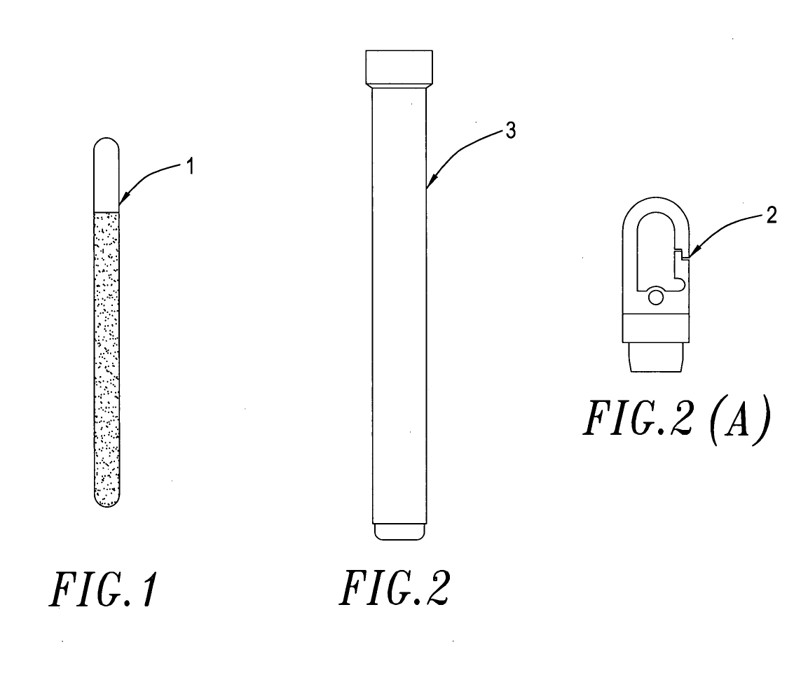

A mixture having 750 mls of dimethyl phthalate, 220 mls of tertial butanol and 0.50 grams of sodium salicylate is stirred at room temperature for one hour. Then slowly add 53 grams of 98% hydrogen peroxide therinto and mix for one hour at room temperature. As shown in FIG. 1, seal this peroxide component in a glass ampule 1.

C. Preparation of the Flexible Outer Container

Referring to FIG. 2, exemplarily flexible, transparent or translucent outer container according to the present invention includes two construction parts. They are hollow plug 2 and cylindrical tube 3. FIG. 3 shows the vertical-sectional view of the hollow plug 2 and cylindrical tube 3. The tube 3 shown in FIG. 2 is prepared by mixing 1% by weight of fluorescer, Day-Glo® Rocket Red ZQ-13 (Day-Glo Color Corp., Cleveland, Ohio) with 99% by weight of low density polyethylene. The mixture is blended and then injection molded to produce the tube 3.

A hollow plug 2 as shown in FIG. 2 is produced by injection-molding. The ingredient is high density polyethylene and incorporates no fluorescer.

D. Assembly of the Multi-Color Chemiluminescent Light Device

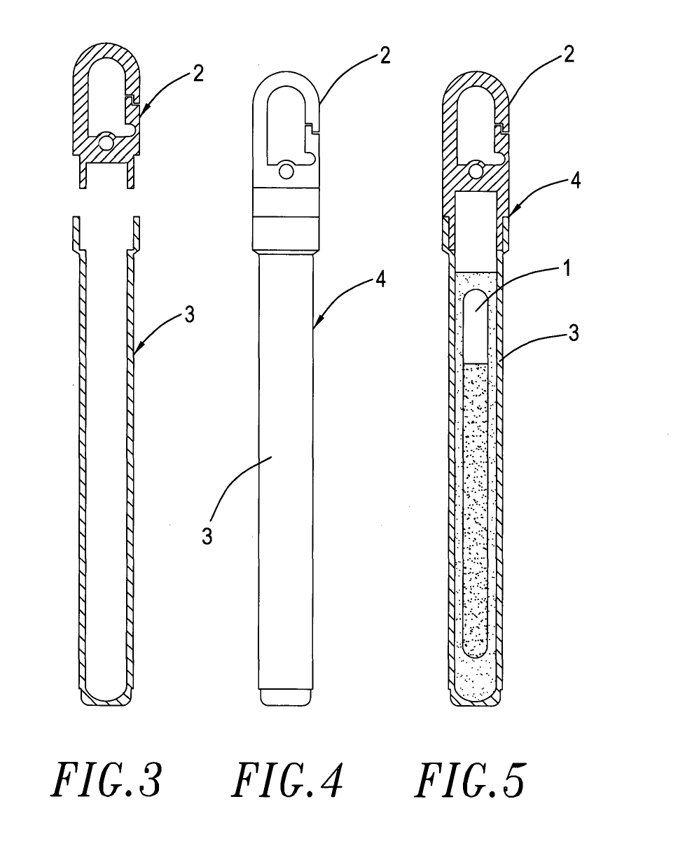

5.5 ml of the chemiluminescent oxalate component prepared by procedure A is added via the open end of the tube 3 which has an outside diameter of about 15 mm, a wall thickness of about 2 mm, and an overall length of about 135 mm. The glass ampule 1, containing 3.3 ml of the peroxide component prepared by procedure B, is inserted into the tube 3. The plug 2 is inserted in the open end of the tube 3 and spin-welded therein to close and seal the tube. FIG. 4 gives the elevational view of this assembled device 4 and FIG. 5 shows a perspective drawing of this assembled device 4.

By bending the tube 3, the glass ampule 1 can be broken and the peroxide component within the ampule 1 can react with the chemiluminescent oxalate component so as to give green light. Because the plug 2 incorporates no fluorescer, the light can transmit through the plug without change of color. However, since the tube 3 incorporates fluorescer Rocket Red ZQ-13, part of light transmitting through the tube 3 will activate the fluorescer incorporated in the tube so as to emit the light in the red color. Therefore, this gives a two-color chemiluminescent light device which emits green light from the plug 2 and emits red light from the tube 3.

The less fluorescer the tube 3 incorporates, the less light will be transformed by the fluorescer in the tube 3. Consequently, by adjusting the amount of fluorescer incorporated into the tube 3, the tube 3 can emit different colors. For example, when incorporating 0.1% by weight of Rocket Red ZQ-13, the tube 3 emits yellow light. When incorporating 0.5% by weight of Rocket Red ZQ-13, the tube 3 emits orange light.

The following table shows some examples of possible fluorescer combinations and the colors that will emit.

| Fluorescer in the | Fluorescer | | |
|---|---|---|---|
| chemiluminescent | incorporated in | Emission color | |
| oxalate component | the tube | Plug side | Tube |
| 9,10-diphenyl- | 9,10-bis(phenylethynyl)- | blue | green |
| anthracene | anthracene in 1 wt % | | |
| 9,10-diphenyl- | Rocket Red ZQ-13 | blue | Pink |
| anthracene | in 0.1 wt % | | |
| 9,10-diphenyl- | Rocket Red ZQ-13 | blue | Purple |
| anthracene | in 0.02 wt % | | |
| 9,10-bis(phenyl- | Neon Red ZQ-12 | green | orange-red |
| ethynyl)anthracene | in 1 wt % | | |
| 1,8-dichloro-9,10- | Rocket Red ZQ-13 | yellow | orange |
| bis(phenylethynyl)- | in 0.3 wt % | | |
| anthracene | | | |

It is apparent that the multi-color chemiluminescent light device according to the present invention has nearly no limitation in its shape design and does not require having a long and narrow dimension as described in prior art, U.S. Pat. No. 5,158,349. Furthermore, this device only requires one chemiluminescent oxalate component, as compared to the multiple oxalate components required in prior art. It does not require any impervious barrier separating two or more chambers that contain different oxalate-fluorescer compounds, either. Thus, when compared to prior arts, this invention is cost-effective, easy to manufacture and has the great advantage of having versitile possibilities in its shape design.

Another embodiment of the multi-color chemiluminescent light device according to the present invention can be prepared by the following procedures:

A. Preparation of Chemiluminescent Oxalate Component

Dissolve 67.5 grams of bis(6-carbopentoxy-2,4,5-tri-chlorophenyl)oxalate in one liter high quality dibutyl phthalate and heat the solution at 150° C. under nitrogen for one hour. Then, cool under nitrogen to 100° C. and add 1.50 grams of a fluorescer compound 9,10-diphenylanthracene thereinto. Finally, cool to room temperature.

B. Preparation of Peroxide Component

A mixture containing 750 mls of dimethyl phthalate, 220 mls of tertial butanol, and 0.50 grams of sodium salicylate is stirred at room temperature for one hour. Then, slowly add 53 grams of 98% hydrogen peroxide and mix for one hour at room temperature. As shown in FIG. 1, seal this peroxide component in a glass ampule 1.

C. Preparation of Flexible Outer Container

Referring to FIG. 2, exemplarily flexible, transparent or translucent outer container according to the present invention includes two construction parts. They are hollow plug 2 and cylindrical tube 3. The tube 3 shown in FIG. 2 is prepared by mixing 1% by weight of fluorescer, Day-Glo® Rocket Red ZQ-13 (Day-Glo Color Corp., Cleveland, Ohio) with 99% by weight of low density polyethylene. The mixture is blended and then injection molded to produce the tube 3.

A hollow plug 2 as shown in FIG. 2 is prepared by mixing 0.4% by weight of fluorescer and 1,8-dichloro-9,10-bis(phenylethynyl)anthracene with 99.6% by weight of high density polyethylene. The mixture is blended and then injection molded to produce the plug 2.

D. Assembly of the Multi-Color Chemiluminescent Light Device

5.5 ml of the chemiluminescent oxalate component prepared by procedure A are added via the open end of the tube 3 which has an outside diameter of about 15 mm, a wall thickness of about 2 mm, and an overall length of about 135 mm. The glass ampule 1, containing 3.3 ml of the peroxide component prepared by procedure B, is inserted into the tube 3. The plug 2 is inserted into the open end of the tube 3 and spin-welded therein to close and seal the tube. FIG. 4 gives the elevational view of this assembled device 4.

By bending the tube 3, the glass ampule 1 can be broken and the peroxide component within the ampule 1 can react with the chemiluminescent oxalate component so as to give the light in the blue color. Because the plug 2 incorporates 1,8-dichloro-9,10-bis(phenylethynyl)anthracene, the light transmitting through the plug 2 will be transformed into yellow color. However, since the tube 3 incorporates fluorescer Rocket Red ZQ-13, light transmitting through the tube 3 will be transformed into red light. So, this embodiment gives a two-color chemiluminescent light device which emits yellow light from the plug 2 and emits red light from the tube 3. Additionally, it is apparent that the flexible, transparent or translucent outer container can have more construction parts than two. Once (1) all of the construction parts incorporate fluorescers and (2) the fluorescer type or incorporation ratio of at least one of the construction parts are different from those of the other construction parts, the device will emits at least two colors. More construction parts having unique fluorescer type or incorporation ratio will give more colors.

With respect to the above description, it is to be realized that the optimum relationships for the parts of the invention, including variations in size, shape, material, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A multi-color chemiluminescent light device, comprising:
a rigid inner tube defining an inner chamber;
a flexible, transparent or translucent outer container with two or more construction parts;
a chemiluminescent oxalate component with fluorescer; and
a peroxide component;
wherein one of said construction parts of said outer container incorporates no fluorescer;
one of the other of said construction parts of the said outer container incorporates fluorescer having emission maximum at a relatively longer wavelength than that of said fluorescer in said chemiluminescent oxalate component and has an absorption spectrum overlapping a substantial portion of the emission spectrum of said fluorescer in said chemiluminescent oxalate component;
said flexible, transparent or translucent outer container and said rigid inner tube defines an outer chamber therebetween; and
said chemiluminescent oxalate component with fluorescer is sealed in said inner chamber and said peroxide componet is placed in said outer chamber, or in a reverse order, said chemiluminescent oxalate component with fluorescer is placed in said outer chamber and said peroxide componet is sealed in said inner chamber.

2. A multi-color chemiluminescent light device as claimed in claim 1, wherein said fluorescer in said chemiluminescent oxalate component is selected from a group consisting of 9,10-diphenylanthracene, 9,10-bis (4-ethoxyphenyl)-2-chloroanthracene, and 9,10-bis(4-methoxyphenyl)-2-chloroanthracene and said fluorescer in said construction parts of said outer container is selected from a group consisting of 9,10-bis(phenylethynyl)anthracene, 1-chloro-9,10-bis(phenylethynyl)anthracene, 1,5-dichloro-9,10-bis(phenyl-ethynyl)anthracene, 1,8-dichloro-9,10-bis(phenyl-ethynyl)anthracene, Aurora Pink ZQ-11, Neon Red ZQ-12, Rocket Red ZQ-13, Rhodamine B, Fire Orange ZQ-14, Blaze Orange ZQ-15, Arc Yellow ZQ-16, Saturn Yellow ZQ-17 and Signal Green ZQ-18.

3. A multi-color chemiluminescent light device as claimed in claim 1, wherein said fluorescer in said chemiluminescent oxalate component is selected from a group consisting of 9,10-bis(phenylethynyl)anthracene, 1-chloro-9,10-bis(phenyl-ethynyl)anthracene, 1,5-dichloro-9,10-bis(phenyl-ethynyl)anthracene, 1,8-dichloro-9,10-bis(phenylethynyl)anthracene and said fluorescer in said construction parts of said outer container is selected from a group consisting of Aurora Pink ZQ-11, Neon Red ZQ-12, Rocket Red ZQ-13, Rhodamine B, Fire Orange ZQ-14 and Blaze Orange ZQ-15.

4. A multi-color chemiluminescent light device, comprising:
a rigid inner tube defining an inner chamber;
a flexible, transparent or translucent outer container with two or more construction parts;
a chemiluminescent oxalate component with fluorescer therein; and
a peroxide component;
wherein all of said construction parts of said outer container incorporate fluorescers having emission maximum at a longer wavelength than that of said fluorescer in said chemiluminescent oxalate component and have an absorption spectrum overlapping a substantial portion of the emission spectrum of said fluorescer in said chemiluminescent oxalate component;
a type of said fluorescer or an incorporation ratio of at least one of said construction parts of said outer container is different from those of the other of said construction parts.
said flexible, transparent or translucent outer container and rigid inner tube defines an outer chamber therebetween; and
said chemiluminescent oxalate component with fluorescer is sealed in said inner chamber and said peroxide component is placed in said outer chamber, or in a reverse order, said chemiluminescent oxalate component with fluorescer is placed in said outer chamber and said peroxide componet is sealed in said inner chamber.

5. A multi-color chemiluminescent light device as claimed in claim 4, wherein said fluorescer in said chemiluminescent oxalate component is selected from a group consisting of 9,10-diphenylanthracene, 9,10-bis(4-ethoxyphenyl)-2-chloroanthracene, 9,10-bis(4-methoxyphenyl)-2-chloroanthracene and said fluorescers in said construction parts of said outer container are selected from a group consisting of 9,10-bis(phenyl-ethynyl)anthracene, 1-chloro-9,10-bis(phenylethynyl)anthracene, 1,5-dichloro-9,10-bis(phenylethynyl)anthracene, 8-dichloro-9,10-bis(phenylethynyl)anthracene, Aurora Pink ZQ-11, Neon Red ZQ-12, Rocket Red ZQ-13, Rhodamine B, Fire Orange ZQ-14, Blaze Orange ZQ-15, Arc Yellow ZQ-16, Saturn Yellow ZQ-17 and Signal Green ZQ-18.

6. A multi-color chemiluminescent light device as claimed in claim 4, wherein said fluorescer in said chemiluminescent oxalate component is selected from a group consisting of 9,10-bis(phenylethynyl)anthracene, 1-chloro-9,10-bis(phenyl-ethynyl)anthracene, 1,5-dichloro-9,10-bis(phenylethynyl)anthracene, 1,8-dichloro-9,10-bis(phenylethynyl)anthracene and said fluorescers in said construction parts of said outer container are selected from a group consisting of Aurora Pink ZQ-11, Neon Red ZQ-12, Rocket Red ZQ-13, Rhodamine B, Fire Orange ZQ-14 and Blaze Orange ZQ-15.
